(19) United States
(12) Patent Application Publication
(10) Pub. No.: US 2007/0179003 A1
(43) Pub. Date: Aug. 2, 2007

(54) Chain

(75) Inventors: Martin Vornehm, Buhl (DE); Andreas Triller, Buhl (DE)

Correspondence Address: ALFRED J MANGELS, 4729 CORNELL ROAD, CINCINNATI, OH, 452412433, US

(73) Assignee: LuK Lamellen und Kupplungsbau Beteiligungs KG, Buhl (DE)

(21) Appl. No.: 11/640,834

(22) Filed: Dec. 17, 2006

Related U.S. Application Data
(60) Provisional application No. 60/752,698, filed on Dec. 21, 2005.

(30) Foreign Application Priority Data
Dec. 17, 2005 (DE) 10 2005 060 597.4
Apr. 12, 2006 (DE) 10 2006 017 143.8

(51) Int. Cl. F16G 13/04; F16G 5/16; F16G 1/21

(52) U.S. Cl. 474/215; 474/245

(57) ABSTRACT

A chain including identically-configured plate elements having at least one through opening that overlaps with through openings of preceding and following plate elements. The plate elements are interconnected with identically-configured rocker members that extend into the plate openings. The rocker members are in the form of pins having an asymmetric cross-sectional shape that includes rolling surfaces and contact point surfaces that engage with the plate opening surfaces. Outer end faces of the rocker members are crowned to provide contact points that are asymmetrically positioned relative to a pin longitudinal central axis. By reversing the rocker member orientation within the plate element through openings, randomization of chain contacts with chain-driven components is achieved, with improved acoustics. And by utilizing identical plate elements and identical rocker members parts manufacture is simplified, as are part inventory requirements.

### BACKGROUND OF THE INVENTION

1. Field of the Invention

The invention relates to a chain, in particular a chain for a continuously variable belt-driven conical-pulley transmission, or a toothed chain. Areas of application for such chains are belt-driven conical-pulley transmissions, as well as toothed chains in general in machinery, for example as a pump drive or transfer chain for 4-wheel-drive power divider transmissions, or engine control chains.

2. Description of the Related Art

In a CVT transmission, i.e., a continuously variable belt-driven conical-pulley transmission, such chains are used to transmit the torque from the driving pulley to the driven pulley. As toothed chains, the chains made up of plate elements and rocker joints and have tooth geometries of the plate elements with which they engage with complementary tooth geometries and thereby also transmit forces or torques.

Such chains made up of rocker joints and plate links usually contain two-piece rocker joints. The rocker joints are composed of two pin elements that extend through an opening in the plates, so that two pin elements extend through an opening of a plate element and of an adjacent plate element, and thus combine the plate elements into a chain. At the same time, they serve to ensure the movability of the chain links in relation to each other and to enable the transmission of power in the chain.

It is known that when the chains are made up of identical plate elements the chain tends to develop increased noise during operation. An effort is therefore made to change the type of plates within the chain to improve the acoustics. For that purpose, it is known to construct chains having identical two-part rocker joints, but having different forms of plates. At the same time, those different plate types serve to prevent intersections. However, it is therefore necessary to keep the different plates separate during production and to install them selectively.

Another alternative is to randomize the two-part rocker joints. For that purpose, the rocker joints are not made from two identical pins but from two different pins, for example a large pin and a small pin. Again, in that case two different parts must be processed separately during production and must be installed by a defined alternation pattern or by a random alternation pattern.

An object of the invention is to provide an economical chain that has good acoustic properties and strength and is simple to produce.

### SUMMARY OF THE INVENTION

The present invention is based on the concept of using only one pin, which has asymmetrical properties and hence results in different rolling behavior depending upon its direction of installation, and whose pressure transmission point, for example to a surface of a conical disk of a belt-driven conical-pulley transmission, changes within a plate element depending upon the installation position of the pin in the plate element.

That means that depending upon the orientation of the pin serving as a rocker joint, of which preferably only a single element is provided per rocker joint, a different spacing is achieved between two adjacent pressure transmission points, or different rolling behavior of the pin in the particular plate openings bordering the pin, for example. For that purpose the pin is usable and insertable in at least two different installation positions in relation to a plate element.

At the same time, it offers the possibility of henceforth using only one plate type instead of up to four, and needing only one pin, while the same randomization can be achieved as with up to four plate types and two pin elements per rocker joint. Thus a great advantage is achieved for the production technique from the fact that the number of parts is significantly reduced and the randomization of the chain structure can be accomplished with only two different elements, namely the pins and the plate elements.

In accordance with a preferred embodiment of the invention, the pin element used as a rocker member is asymmetrical in terms of central symmetry and/or axial symmetry, wherein the relevant axis for axial symmetry is an axis perpendicular to the longitudinal direction of the chain in the extended state, so that the central axis of a pin element, that is, through the pin cross section perpendicular to the pin axis, can be defined as the line bisecting the maximum width of the rocker member in the longitudinal direction of the chain.

Advantageously, the chain can be in the form of a toothed chain, so that the plate elements are toothed chain elements including a tooth geometry, preferably with two teeth on each plate element. At the same time, the teeth can also have a slightly varied tooth geometry to improve the acoustics of the chain. The purpose of that is so that when the chain is installed in one direction or the other, different meshing conditions of the teeth with the opposite parts are also achieved.

In accordance with a preferred embodiment, the chain is used as a chain for a belt-driven conical-disk transmission (CVT transmission). Each pin preferably has an end face with an end face contact region for contact with surfaces of the conical disks of conical disk pair of the CVT transmission, for example, by which the transmission of force takes place. For example, the end faces can be designed as a convex surface, whose maximum projection is the eccentric end face contact point.

Preferably, the plate elements are designed so that each plate element has only a single through opening, which overlaps both the through opening of the preceding plate element and the through opening of the subsequent plate element when the chain is assembled. Thus, two rocker joints can be provided by means of a single plate through opening.

Preferably, each rocker member is made of only a single pin, so that each rocker joint has a pin and an associated plate contact region or rolling region.

In accordance with a preferred embodiment, each pin is designed with two rolling surfaces, so that the contact surface of the pins is formed as a second rolling surface. The rolling surfaces can be centrally symmetrical or centrally asymmetrical relative to each other. With centrally asymmetrical rolling surfaces, the result is that different rolling behavior of the pins on the plate elements is achieved, in particular the contact surface region and the rolling surface region of the plate element, depending upon the installation position of the pin in the through opening of —the plate elements.

Alternatively, the contact surface of the pin is designed as a non-rolling bearing surface, so that the pin, depending upon its installation position in the plate opening or plate bore, either meets an opposing rolling surface of the rolling surface of the pin at approximately the center of the height of the bore, for example, and is in rolling contact with the latter, or it bumps against an opposing contact surface, above and below the rolling surface, for example, if it is installed in the plate opening in the opposite orientation. The contact surface of the pin interacts with the opposing bearing surface, or opposing contact surface, and does not roll there. Instead, relative motion between the rocker member and the plate element is largely prevented in that installation position, if the contact surface of the rocker member and the contact surface region of the plate element are designed as bearing surfaces and are abutting against each other.

Because of that arc-shaped or s-shaped pattern, for example, when designing the pin and the plate opening, it continues to be possible that despite the different functions that are integrated into the pin and the plate opening, the plate opening has a producible form, and in particular tight radii or sharp corners are avoided.

Because of the fact that preferably each rocker member is made of only a single pin, the plate openings for the single pin can be made smaller than is the case when using two pins for each rocker joint. That makes it possible to shorten the plates, and thus to reduce the link pitch of the chain and thus the pitch of the pins.

### BRIEF DESCRIPTION OF THE DRAWINGS

The structure, operation, and advantages of the present invention will become further apparent upon consideration of the following description, taken in conjunction with the accompanying drawings in which:

FIG. 1 is a fragmentary cross-sectional view of a first embodiment of a chain segment in accordance with the invention;

FIG. 2 is a fragmentary cross-sectional view of a different pin installation position of a chain segment made up of the same elements as in FIG. 1;

FIG. 3 is a fragmentary cross-sectional view of an alternative embodiment of a chain segment in accordance with the invention;

FIG. 4 is a perspective view of a rocker member in accordance with the invention;

FIG. 4A is a perspective view of an alternative version of a rocker member in accordance with the invention;

FIG. 4B is a cross-sectional view of the rocker member shown in FIG. 4A;

FIG. 5 is a side view of a schematic representation of an embodiment of a chain in accordance with the invention;

FIG. 6 is a side view of an alternative embodiment of a chain in accordance with the invention and in a schematic view;

FIG. 7 is a fragmentary side view of a different alternative embodiment for a chain segment;

FIGS. 7A and 7B show side views of alternative embodiments of link plates;

FIG. 8 is a side view of a chain arrangement in accordance with the invention for the chain segment shown in FIG. 7; and

FIG. 9A is a graph showing the measured plate force during a chain revolution for a chain having two-piece rocker members, along with a side view of the physical arrangement; and

FIG. 9B is a graph showing the measured plate force in a chain revolution for a chain with a one-piece rocker member, along with a side view of the physical arrangement.

### DESCRIPTION OF THE PREFERRED EMBODIMENTS

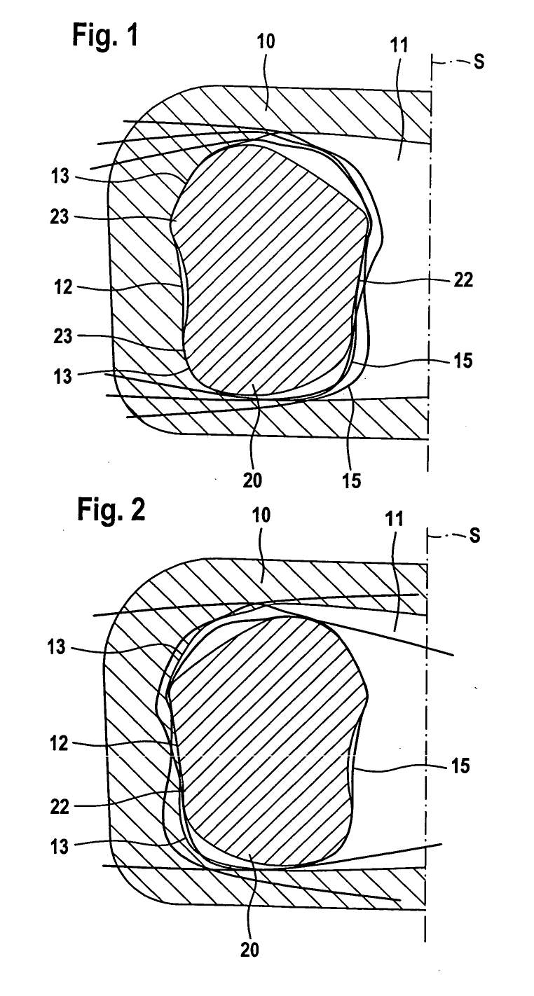

FIG. 1 shows a portion of a plate element 10 with a rocker member 20 in accordance with the invention. Rocker member 20 is shown in cross section in FIG. 1, and is designed as a pin whose longitudinal axis extends perpendicular to the drawing plane. One half of plate element 10 is shown in FIG. 1. The other half is symmetrical to the half that is shown, relative to the axis of symmetry S for a plate element 10. Axis of symmetry S lies in a plane that is perpendicular to the plane of longitudinal extension of a chain when the chain is in the extended condition.

FIG. 1 also shows schematically by lines 15, which indicate the position of an opening of an adjacent plate element 10 on the left side, the positions of the second adjacent plate element on the left side in various movement conditions, and various rolling conditions of rocker member 20 relative to plate element 10.

Plate element 10 has a through opening 11. Together with the left-side adjacent plate element 10 and its opening 11 and the right-side adjacent plate element 10 and its opening 11, it is possible to insert two separate rocker members 20 into the one through opening 11. Each rocker member forms a rocker joint with plate element 10, and thus form two rocker joints to the preceding and the following plate elements 10, respectively, with the adjacent wall regions of the through openings 11.

Through opening 11, which is likewise of symmetrical design relative to the axis S, has a convex rolling surface region 12, at a middle height in the direction of the plate element axis, arched toward the center of the plate element, and above and below it adjacent contact surface regions 13 that are formed as concavely curved regions. As can be seen schematically from the line shape of the outlines of adjacent plate element 10 (lines 15), adjacent plate element 10 is of identical design and also has concavely curved contact regions 13 and a convexly curved rolling surface region 12 lying between the concavely curved regions 13, as boundaries of the contour of the opening.

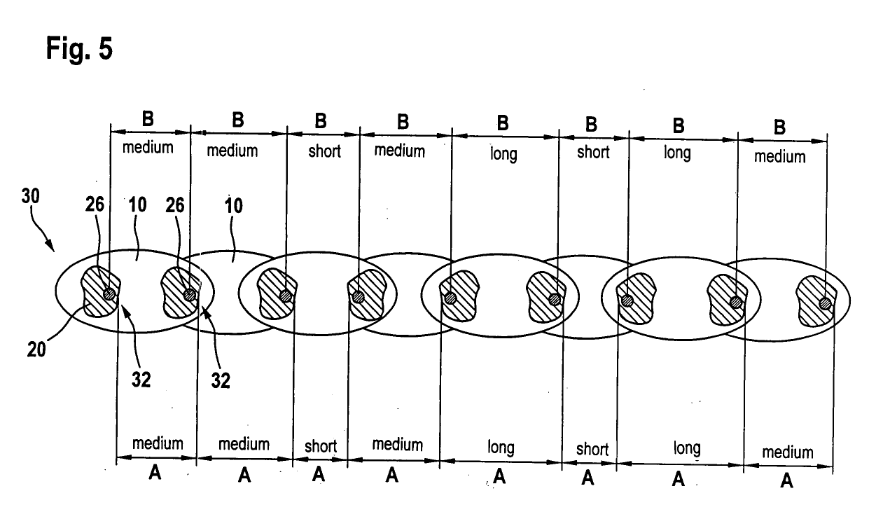

Rocker member 20 is of central point asymmetrical design with regard to its cross section. In particular, it has (on the left side in FIG. 1) two convexly curved contact surfaces 23, and on the opposite side a rolling surface 22. Preferably rocker member 20, in the form of a pin, is provided with identical cross sections along its longitudinal axis, except for the region of the end face (see FIG. 4).

In FIG. 1 rocker member 20 is inserted into the through opening 11 of the plate element in such a way that the convex contact surfaces 23 of rocker member 20 are in contact with the contact surface regions 13 of plate element 10, and hence do not roll on it but are largely fixed relative to it. A second rocker member 20 (not shown) that is guided by the plate element 10 shown in FIG. 1, can either be inserted in mirror image symmetry relative to axis S, or it can be in the same orientation as the rocker member 20 that is shown for the left half of plate element 10 in FIG. 1. The various installation options produce randomization.

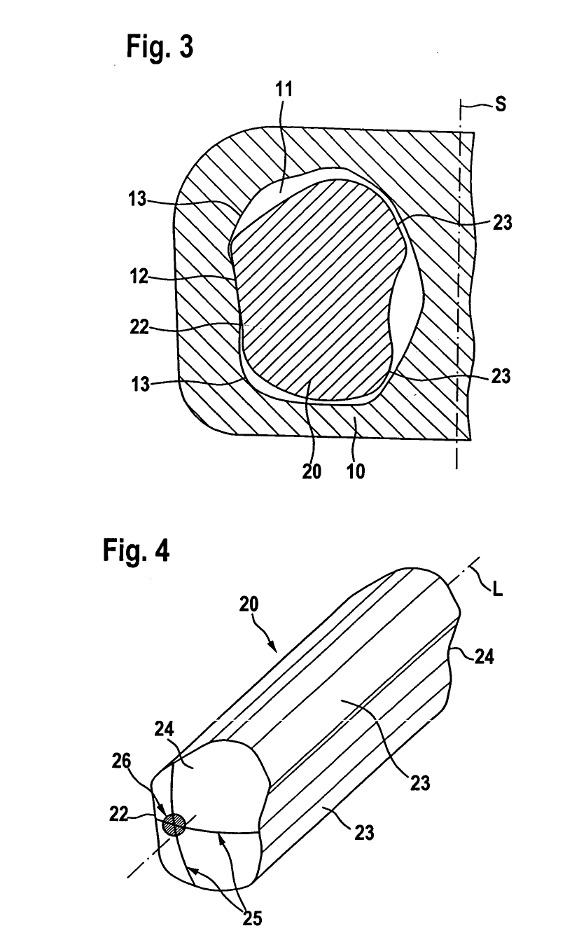

FIG. 2 shows the situation in which a pin that is identical to rocker member 20 is inserted into a plate element identical to that in FIG. 1, likewise in its left half, but with the orientation of the pin rotated. In contrast to FIG. 1, in which the right side plate (shown) is firmly abutting against rocker member 20 because of the installation orientation of rocker member 20, and the left side plate (shown by lines 15) rolls on the pin or rocker member 20, in the mirror image installation of FIG. 2 the left plate element 10 rolls on rocker member 20, since the rolling surface region 12 of through opening 11 and the rolling surface 22 of rocker member 20 roll on each other. The right plate (shown by lines 15) abuts firmly on rocker member 20 and does not roll. The contact surface regions 13 of through opening 11 of the right plate 10 shown in FIG. 2 have no function.

Hence, with the same geometric design of the plate elements 10 and the rocker members 20, because of the mirror image installation of the rocker member 20 in a particular plate element the functions of the individual edge regions of the through opening 11 of the plate element are utilized differently. As a result, by changing the function and through random installation of the rocker members 20 in the one direction or the other, randomization of the functions can be achieved.

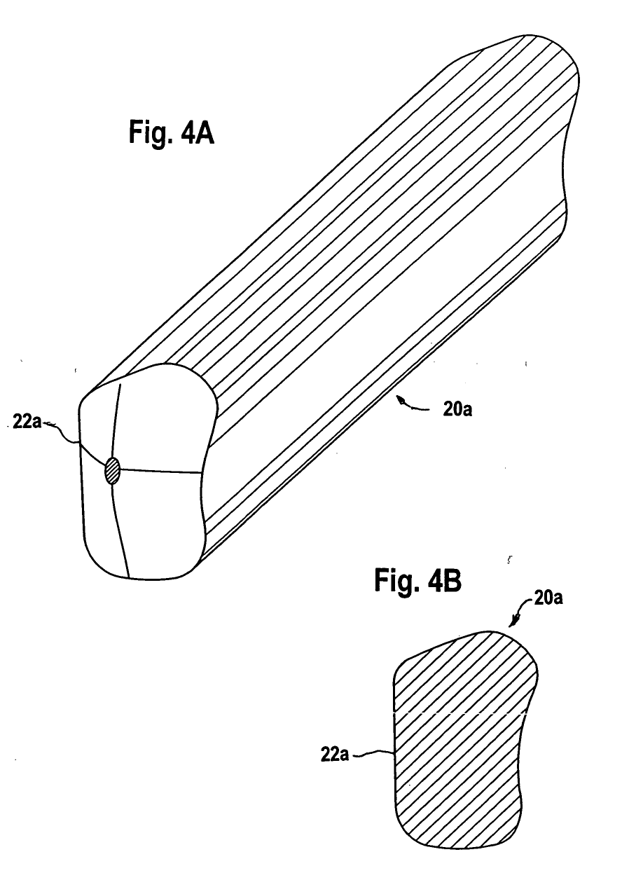

FIG. 3 shows an embodiment of plate element 10 in which two separate through openings 11 or plate throughbores are provided for the rocker joint region to the left-hand adjacent plate element and the rocker joint region to the right-hand adjacent plate element. The design of the functional surfaces that form the contour of the through opening 11, as contact surface regions 13 and rolling surface region 12 between the contact surface regions 13, is identical to the embodiment shown in FIGS. 1 and 2. The pin geometry of the rocker member 20 is likewise identical. FIG. 3 shows the situation in which a rolling contact is established between the rolling surface 22 of rocker member 20 and the rolling surface region 12 of plate element 10. With the adjacent plate element 10 on the left (not shown), which has a geometry identical to that of the illustrated plate element 10, the contact region 23 of rocker member 20 enters into a non-rolling contact with the contact surface 13 of plate element 10.

FIG. 4 shows a perspective view of the rocker member 20 for the arrangement shown in FIGS. 1 through 3. Along the longitudinal axis L of the pin, the rocker member 20 has the identical cross-sectional contour, which is recognizable in cross section in FIGS. 1 through 3 and has already been described.

The end faces 24 of rocker member 20 are designed as convex end faces, preferably with a crowning 25 or convexity provided in two directions perpendicular to each other, so that a furthest protruding point results that is the end face contact point 26. Because of the particular design of the crowning 25, the end face contact point 26 is preferably situated asymmetrically relative to a center axis of the pin element, which center axis is perpendicular to the longitudinal axis L of the pin and parallel to the axis of symmetry S of the plate element 10, i.e., perpendicular to the chain extension direction when the chain 30 is extended longitudinally. End face contact point 26 is preferably not positioned on that axis, which produces its asymmetry on the end face 24. End face contact point 26 is that point with which the rocker joints 20 come into pressure contact with the conical disks of a belt-driven conical-pulley transmission, for example.

FIGS. 4A and 4B show an alternative embodiment of a rocker member 20a in which concave rolling surface region 22 of pin 20 shown in FIG. 1 is replaced by flat surface region 22a.

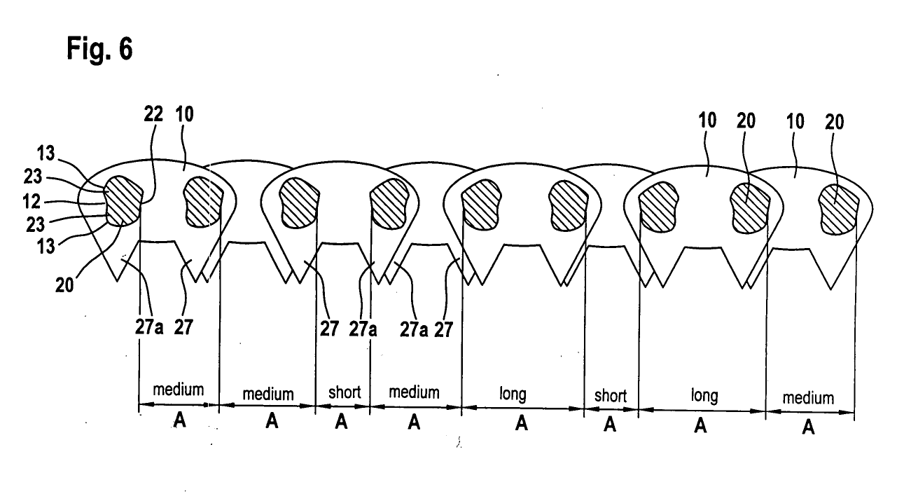

FIG. 5 shows a schematic side view of a portion of a chain 30 that utilizes the chain elements shown in FIGS. 1 through 4. In particular, the plate elements 10 are shown schematically in FIG. 5. As can be seen from FIG. 5, the rocker members 20 are installed randomly in the positions shown in FIG. 1 or in FIG. 2. That results in a random distribution of the spacings B between each pair of adjacent end face contact points 26, and a random distribution of the pitch spacings A between adjacent rocker joints 32. In particular, if two pins are installed in a plate element 10 one after the other in the same orientation, such as the first two pins starting from the left in FIG. 5, the result is both medium rolling surface spacings A and medium end face contact point spacings B. If the left rocker member is installed in a plate element in the orientation of FIG. 1 and the rocker member to its right is installed in mirror image symmetry to it, as in the case of the third and fourth rocker members 20, as viewed from the left in FIG. 5, the result is short spacings B of the end face contact points 26 and short rolling spacings A. Finally, if the left rocker member in a plate element 10 is installed in the installation position of FIG. 2 and the right rocker member is installed in mirror image symmetry to it, as in the case of rocker members 5 and 6, As viewed from the left in FIG. 5, it produces a long spacing B between the end face contact points 26 and a long rolling spacing B. Thus, it is possible to achieve three different rolling spacings A and three different contact point spacings B of the end face contact points 26 while using only one form of plate element 10 and one form of rocker member 20, which also alternate in a random sequence along the chain 30 when the arrangement of the rocker members 20 is randomized.

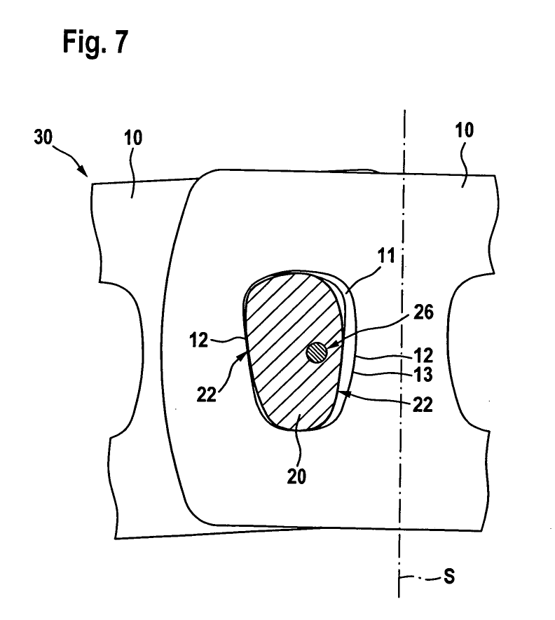

FIG. 6 shows the use of the geometry for plate elements 10 and rocker members 20 in accordance with the invention for toothed plate elements. As can be seen from FIG. 6, each plate element 10 has two schematically shown teeth 27, 27a. The tooth geometries can likewise differ from each other in accordance with need and thus contribute to randomization of the tooth engagement, depending upon the installation direction of the plate elements 10. The configuration of the end faces of the rocker members 20 is not significant in that case. The figure shows the randomization of the rolling spacings A. The cross-sectional geometry of the rocker members 20 and of the through openings 11 of the plate elements is as shown in FIGS. 1 through 3.

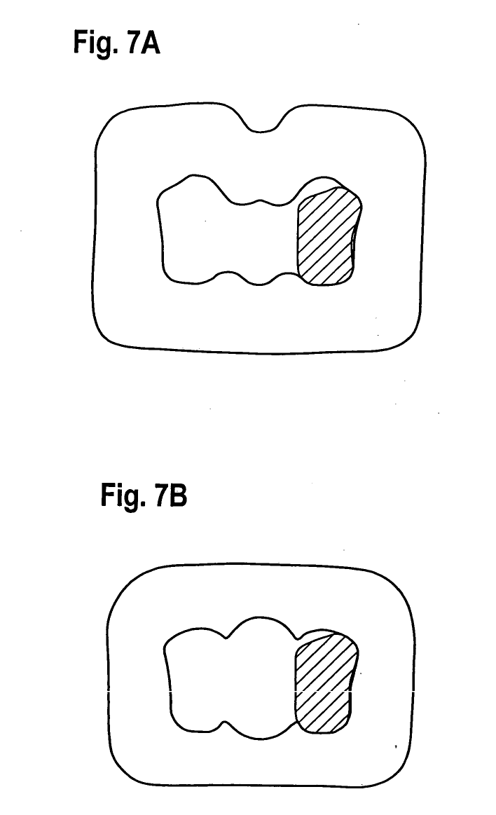

FIG. 7 shows an alternative embodiment for the geometry of the through openings 11 of the plate elements 10 and of rocker members 20. An end face contact point 26 is again provided asymmetrically on the ends of each rocker member 20. The plate elements 10 are symmetrically structured relative to the axis of symmetry S.

In contrast to the plate elements 10 and rocker members 20 described in connection with FIGS. 1 through 6, each rocker member 20 of FIG. 7 has two rolling surfaces 22, i.e., the contact surface 23 shown in FIG. 1 is designed as a second rolling surface 22. The rolling surfaces are provided on sides lying opposite each other relative to a central axis through rocker member 20 that is parallel to the axis S of the plate elements when the chain is extended longitudinally. The end face contact point 26 lies outside the axis; that is, it is asymmetrically positioned on the end of rocker member 20. The rolling surfaces 22 are preferably of different form, in particular if the noise reduction of the chain 30 is to be achieved by randomizing both the spacings B of the end face contact points 26 and the rolling spacings A. The through openings 11 of the plate elements 10, of which each plate element 10 has two, also have two oppositely positioned rolling surface regions 12. Instead of designing the pin geometries differently with respect to each other in regard to the rolling surface regions 12, the two rolling surface regions 12 of a through opening 11 of the plate element 10 can also have different geometries. That means that in the embodiment shown in FIG. 7 a contact surface region 13 of the plate element 10 is designed as a rolling surface region 12, and a contact surface of the rocker member 20, in the form of a pin, is likewise designed as a rolling surface 22.

FIGS. 7A and 7B show differently configured plate elements 10A and 10B, respectively. As can be seen, the through openings 11A and 11B differ in their overall configuration, while the rocker members 20 are of the same cross-sectional form.

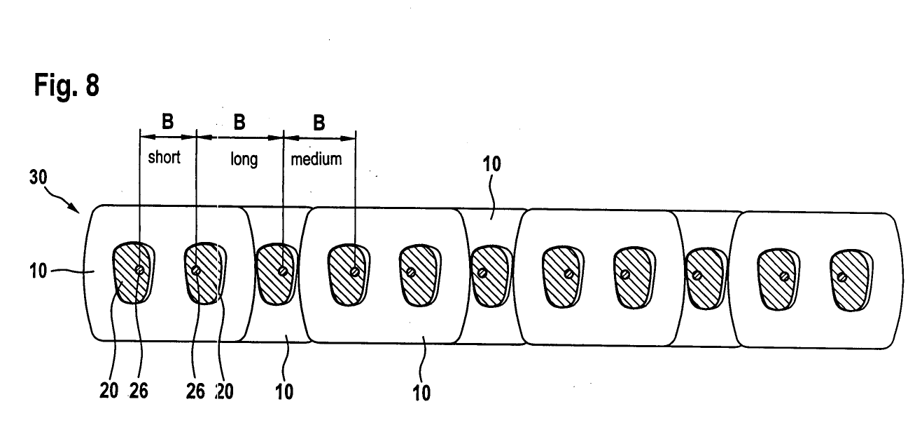

With the end face contact points 26 positioned eccentrically on the ends of rocker members 20, and with the rocker members aligned at random in the plate through openings 11 within a chain such as chain 30 of FIG. 5, it is again possible, as shown in FIG. 8, to achieve different spacings B of the end face contact points 26. If either the through openings 11 of the plate elements 10 or the cross sections of the rocker members 20 are of asymmetrical design in terms of central point symmetry, then a randomizing of the rolling spacings (not shown in FIG. 8) is also possible.

In each of the illustrated embodiments, the randomization is made possible with a single configuration of the plate elements 10 and a single configuration of the rocker members 20.

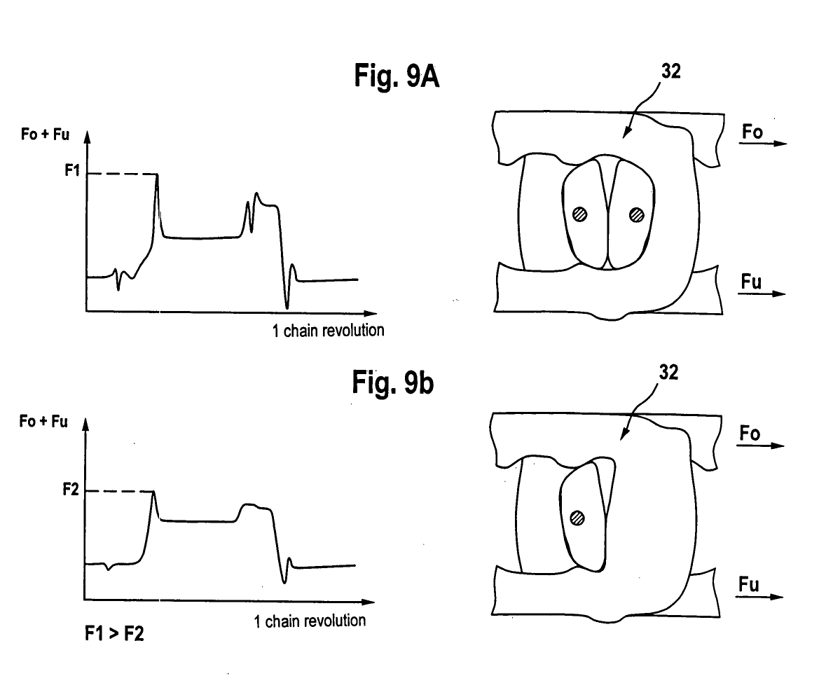

The advantages of utilizing a one-piece rocker member 20, with which a rocker joint 32 can be formed from a single rocker member 20 and the corresponding plate opening 11, are illustrated in FIGS. 9A and 9B in comparison to two-piece rocker members. The graph in FIG. 9A shows the measured total longitudinal force acting on a plate element during one chain revolution for a two-piece rocker joint 32, while the graph in FIG. 9B shows the measured total longitudinal force acting on a plate element for a one-piece rocker joint 32. FIGS. 9A and 9B register, respectively, the sums of the upper forces Fₒ and the lower forces Fᵤ acting at the regions of the plate elements 10 a shown at the right sides of FIGS. 9A and 9B. It can be seen that damaging force peaks in the plates can be moderated through the use of only one pin as the rocker member 20, and thus the changed rolling kinematics that accompany the force peaks can be reduced. That contributes to the reliability and durability of the chain. In addition, because of the small number of parts needed, a production advantage can be achieved, as is necessary in particular for small businesses and in the case of toothed chains.

Although particular embodiments of the present invention have been illustrated and described, it will be apparent to those skilled in the art that various changes and modifications can be made without departing from the spirit of the present invention. It is therefore intended to encompass within the appended claims all such changes and modifications that fall within the scope of the present invention.

What is claimed is:

1. A chain comprising:
a plurality of plate elements each having at least one through opening that overlaps in a first region with a through opening of a preceding adjacent plate element and in a second region with a through opening of a subsequent adjacent plate element, wherein the at least one through opening of a plate element includes a rolling surface region and a contact surface region,
a plurality of rocker members that interconnect the plate elements and that each extend into through openings in adjacent plate elements, so that the rocker members contact at least one of a rolling surface region and a contact surface region of each of at least two adjacent plate elements,
wherein the rocker members are in the form of pins with at least a first pin peripheral region defining a rolling surface and at least a second pin peripheral region defining a contact surface, and wherein pin rolling surfaces contact at least one of a plate element rolling surface region and a plate element contact surface region of a plate element through opening, and wherein pin contact surfaces contact at least one of a plate element rolling surface region and a plate element contact surface region of a plate element through opening,
wherein at least one of the first region and the second region of the plate elements and at least one of the rolling surface and the contact surface of the pin circumference are centrally asymmetrical relative to each other, and
wherein an end face contact point of a pin end face is eccentric relative to a central axis through a cross section of the pin that is parallel to a plane perpendicular to a direction of extension of the chain when the chain is in an extended state.

2. A chain in accordance with claim 1, wherein the pin has a central axis defined by a line passing through a pin cross section that is perpendicular to the pin axis and bisecting a maximum width of the rocker member in the longitudinal direction of the chain.

3. A chain in accordance with claim 1, wherein the chain is a toothed chain and the plate elements include toothed chain elements having a tooth geometry, wherein the chain elements each include two teeth.

4. A chain in accordance with claim 1, wherein the chain is a chain for a continuously variable, belt-driven conical-pulley transmission having pairs of conical disk about which the chain passes, and the end face contact point is a force transmission point between the chain and a conical disk.

5. A chain in accordance with claim 4, wherein an eccentric end face contact point is provided on both pin end contact surfaces.

6. A chain in accordance with claim 1, wherein the end face is a convex surface having point of maximum projection that is the end face contact point.

7. A chain in accordance with claim 1, wherein the first and second regions of each plate element are formed in a single plate element through opening.

8. A chain in accordance with claim 1, wherein each plate element has two through openings, and wherein each through opening includes at least one contact surface region.

9. A chain in accordance with claim 1, wherein each rocker member is in the form of a single pin.

10. A chain in accordance with claim 1, wherein the contact surface of the pin is a second rolling surface of the pin.

11. A chain in accordance with claim 1, wherein the contact surface of the pin is a non-rolling bearing surface.

12. A chain in accordance with claim 1, wherein the contact surface region of the plate element is a second rolling surface region of the plate element.

13. A chain in accordance with claim 1, wherein the contact surface region of the plate element is centrally symmetrical to the rolling surface region and provides a combined bearing surface and rolling surface.

14. A rocker member for a chain, said rocker member comprising: a pin having at least a first pin peripheral region defining a rolling surface and at least a second pin peripheral region defining a contact surface, wherein at least one of the rolling surface and the contact surface of the pin circumference are centrally asymmetrical relative to each other, and wherein an end face contact point of a pin end face is eccentric relative to a central axis through a cross section of the pin that is parallel to a plane perpendicular to a direction of extension of a chain when the chain is in an extended state.

15. A belt-driven conical-pulley transmission with a chain for transmitting torque said transmission comprising:
two pairs of conical disks about which the chain passes to transmit torque therebetween, and
a chain including a plurality of plate elements each having at least one through opening that overlaps in a first region with a through opening of a preceding adjacent plate element and in a second region with a through opening of a subsequent adjacent plate element, wherein the at least one through opening of a plate element includes a rolling surface region and a contact surface region,
a plurality of rocker members that interconnect the plate elements and that each extend into through openings in adjacent plate elements, so that the rocker members contact at least one of a rolling surface region and a contact surface region of each of at least two adjacent plate elements,
wherein the rocker members are in the form of pins with at least a first pin peripheral region defining a rolling surface and at least a second pin peripheral region defining a contact surface, and wherein pin rolling surfaces contact at least one of a plate element rolling surface region and a plate element contact surface region of a plate element through opening, and wherein pin contact surfaces contact at least one of a plate element rolling surface region and a plate element contact surface region of a plate element through opening,
wherein at least one of the first region and the second region of the plate elements and at least one of the rolling surface and the contact surface of the pin circumference are centrally asymmetrical relative to each other, and
wherein an end face contact point of a pin end face is eccentric relative to a central axis through a cross section of the pin that is parallel to a plane perpendicular to a direction of extension of the chain when the chain is in an extended state.
